(19) United States
(12) Patent Application Publication
(10) Pub. No.: US 2011/0314256 A1
(43) Pub. Date: Dec. 22, 2011

(54) Data Parallel Programming Model

(75) Inventors: Charles David Callahan, II, Seattle, WA (US); Paul F. Ringseth, Bellevue, WA (US); Yosseff Levanoni, Redmond, WA (US); Weirong Zhu, Issaquah, WA (US); Lingli Zhang, Sammamish, WA (US)

(73) Assignee: Microsoft Corporation, Redmond, WA (US)

(21) Appl. No.: 12/819,097

(22) Filed: Jun. 18, 2010

(51) Int. Cl. G06F 15/76; G06F 9/02; G06F 9/30

(52) U.S. Cl. 712/17; 712/30; 712/E09.002; 712/225; 712/E09.016

(57) ABSTRACT

Described herein are techniques for enabling a programmer to express a call for a data parallel call-site function in a way that is accessible and usable to the typical programmer. With some of the described techniques, an executable program is generated based upon expressions of those data parallel tasks. During execution of the executable program, data is exchanged between non-data parallel (non-DP) capable hardware and DP capable hardware for the invocation of data parallel functions.

### BACKGROUND

In data parallel computing, the parallelism comes from distributing large sets of data across multiple simultaneous separate parallel computing operators or nodes. In contrast, task parallel computing involves distributing the execution of multiple threads, processes, fibers or other contexts, across multiple simultaneous separate parallel computing operators or nodes. Typically, hardware is designed specifically to perform data parallel operations. Therefore, data parallel programming is programming written specifically for data parallel hardware. Traditionally, data parallel programming requires highly sophisticated programmers who understand the non-intuitive nature of data parallel concepts and are intimately familiar with the specific data parallel hardware being programmed.

Outside the realm of super computing, a common use of data parallel programming is graphics processing, because such processing is data intensive and specialized graphics hardware is available. More particularly, a Graphics Processing Unit (GPU) is a specialized many-core processor designed to offload complex graphics renderings from the main central processing unit (CPU) of a computer. A many-core processor is one in which the number of cores is large enough that traditional multi-processor techniques are no longer efficient—this threshold is somewhere in the range of several tens of cores. While many-core hardware is not necessarily the same as data parallel hardware, data parallel hardware can usually be considered to be many-core hardware.

Other existing data parallel hardware includes Single instruction, multiple data (SIMD) Streaming SIMD Extensions (SSE) units in x64 processors available from contemporary major processor manufactures.

Typical computers have historically been based upon a traditional single-core general-purpose CPU that was not specifically designed or capable of data parallelism. Because of that, traditional software and applications for traditional CPUs do not use data parallel programming techniques. However, the traditional single-core general-purpose CPUs are being replaced by many-core general-purpose CPUs.

While a many-core CPU is capable of functionality, little has been done to take advantage of such functionality. Since traditional single-core CPUs are not data parallel capable, most programmers are not familiar with data parallel techniques. Even if a programmer was interested, there remains the great hurdle for the programmer to fully understand the non-intuitive nature of the data parallel concepts and to learn enough to be sufficiently familiar with the many-core hardware to implement those concepts.

If a programmer clears those hurdles, they may recreate such programming for each particular many-core hardware arrangement where they wish for their program to run. That is, because conventional data parallel programming is hardware specific, the particular solution that works for one many-core CPU arrangement will not necessarily work for another. Since the programmer programs their data parallel solutions for the specific hardware, the programmer faces a compatibility issue with differing hardware.

Presently, no solution exists that enables a typical programmer to perform data parallel programming. A typical programmer is one who does not fully understand the non-intuitive nature of the data parallel concepts and is not intimately familiar with each incompatible data-parallel hardware scenario. Furthermore, no present general and productive solution exists that allows a data parallel program to be implemented across a broad range of hardware that is capable of data parallelism.

### SUMMARY

Described herein are techniques for enabling a programmer to express a call for a data parallel call-site function in a way that is accessible and usable to the typical programmer. With some of the described techniques, an executable program is generated based upon expressions of those data parallel tasks. During execution of the executable program, data is exchanged between host hardware and hardware that is optimized for data parallelism, and in particular, for the invocation of data parallel call-site functions.

This Summary is provided to introduce a selection of concepts in a simplified form that is further described below in the Detailed Description. This Summary is not intended to identify key features or essential features of the claimed subject matter. The term “techniques,” for instance, may refer to device(s), system(s), method(s), and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an example computing environment is usable to implement techniques for the data parallel programming model described herein.

FIGS. 2 and 3 are flow diagrams of one or more example processes, each of which implements the techniques described herein.

### DETAILED DESCRIPTION

Described herein are techniques enabling a programmer to express a call for a data parallel call-site function in a way that is accessible and usable to the typical programmer. With some of the described techniques, an executable program is generated based upon expressions of those data parallel tasks. The executable program includes calls for data parallel (“DP”) functions that perform DP computations on hardware (e.g., processors and memory) that is designed to perform data parallelism. During execution of the executable program, data is exchanged between host hardware and hardware that is optimized for data parallelism, and in particular, for the invocation of DP functions. Some of the described techniques enable a programmer to manage DP hardware resources (e.g., memory).

To achieve a degree of hardware independence, the implementations are described as part of a general-purpose programming language that may be compiled. The C++ programming language is the primary example of such language as is described herein. C++ is a statically-typed, free-form, multi-paradigm, compiled, general-purpose programming language. C++ may also be described as imperative, procedural, object-oriented, and generic. The C++ language is regarded as a mid-level programming language, as it comprises a combination of both high-level and low-level language features. The inventive concepts are not limited to expressions in the C++ programming language. Rather, the C++ language is useful for describing the inventive concepts. Examples of some alternative programming language that may be utilized include Java™, C, PHP, Visual Basic, Perl, Python™, C#, Ruby, Delphi, Fortran, VB, F #, OCaml, Haskell, Erlang, _NESL, and JavaScript™. That said, some of the claimed subject matter may cover specific programming expressions in C++ type language, nomenclature, and format.

Some of the described implementations offer a foundational programming model that puts the software developer in explicit control over many aspects of the interaction with DP resources. The developer allocates DP memory resources and launches a series of DP call-site functions which access that memory. Data transfer between non-DP resources and the DP resources is explicit and typically asynchronous.

The described implementations offer a deep integration with a compiled general-purpose programming language (e.g., C++) and with a level of abstraction which is geared towards expressing solutions in terms of problem-domain entities (e.g., multi-dimensional arrays), rather than hardware or platform domain entities (e.g., C-pointers that capture offsets into buffers).

The described embodiments may be implemented on DP hardware such as those using many-core processors or SIMD SSE units in x64 processors. Some described embodiments may be implemented on clusters of interconnected computers, each of which possibly has multiple GPUs and multiple SSE/AVX (Advanced Vector Extensions)/LRBni (Larrabee New Instruction) SIMD and other DP coprocessors.

A following co-owned U.S. patent application is incorporated herein by reference and made part of this application: U.S. Ser. No. ______, filed on June ______, 2010 [it is titled: “Compiler-Generated Invocation Stubs for Data Parallel Programming Model,” filed on the same day at this application, and having common inventorship].

### Example Computing Infrastructure

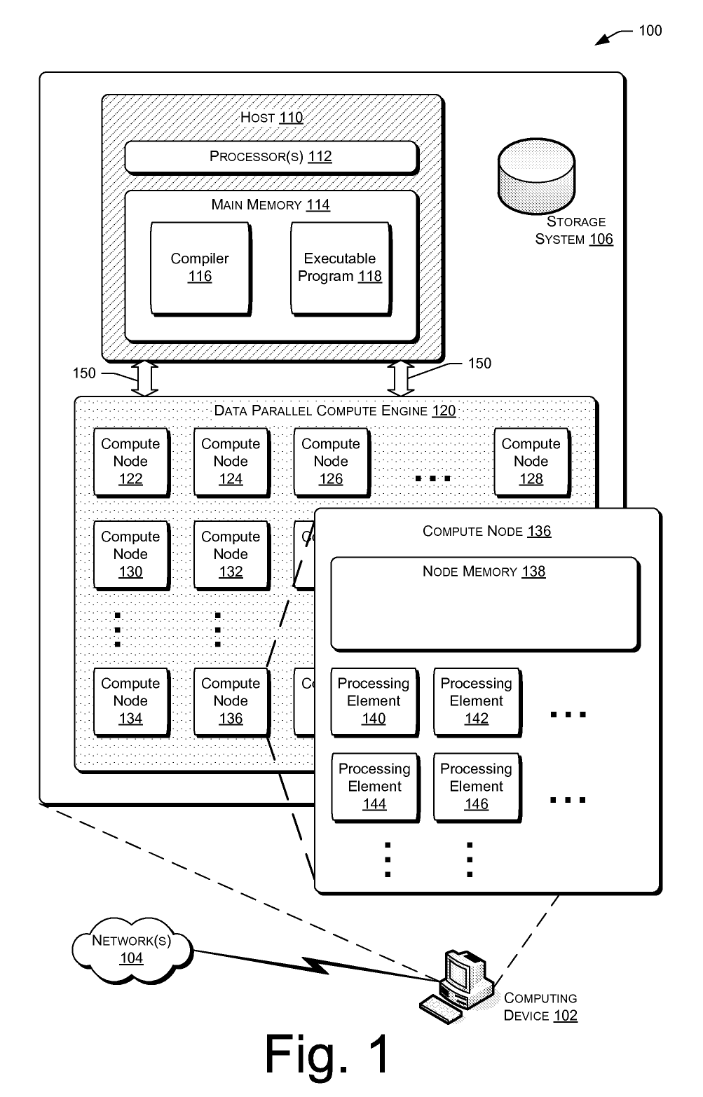

FIG. 1 illustrates an example computer architecture 100 that may implement the techniques described herein. The architecture 100 may include at least one computing device 102, which may be coupled together via a network 104 to form a distributed system with other devices. While not illustrated, a user (typically a software developer) may operate the computing device while writing a data parallel (“DP”) program. Also not illustrated, the computing device 102 has input/output subsystems, such as a keyboard, mouse, monitor, speakers, etc. The network 104, meanwhile, represents any one or combination of multiple different types of networks interconnected with each other and functioning as a single large network (e.g., the Internet or an intranet). The network 104 may include wire-based networks (e.g., cable) and wireless networks (e.g., cellular, satellite, etc.).

The computing device 102 of this example computer architecture 100 includes a storage system 106, a non-data-parallel (non-DP) host 110, and at least one data parallel (DP) compute engine 120. In one or more embodiments, the non-DP host 110 runs a general-purpose, multi-threaded and non-DP workload, and performs traditional non-DP computations. In alternative embodiments, the non-DP host 110 may be capable of performing DP computations, but not the computations that are the focus of the DP programming model. The host 110 (whether DP or non-DP) “hosts” the DP compute engine 120. The host 110 is the hardware on which the operating system (OS) runs. In particular, the host provides the environment of an OS process and OS thread when it is executing code.

The DP compute engine 120 performs DP computations and other DP functionalities. The DP compute engine 120 is the hardware processor abstraction optimized for executing data parallel algorithms. The DP compute engine 120 may also be called the DP device. The DP compute engine 120 may have a distinct memory system from the host. In alternative embodiments, the DP compute engine 120 may share a memory system with the host.

The storage system 106 is a place for storing programs and data. The storage system 106 includes a computer-readable media, such as, but not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive).

The non-DP host 110 represents the non-DP computing resources. Those resources include, for example, one or more processors 112 and a main memory 114. Residing in the main memory 114 are a compiler 116 and one or more executable programs, such as program 118. The compiler 116 may be, for example, a compiler for a general-purpose programming language that includes the implementations described herein. More particularly, the compiler 116 may be a C++ language compiler. The program 118 may be, at least in part, an executable program resulting from a compilation by the compiler 116. Consequently, at least a portion of program 118 may be an implementation as described herein. Both the compiler 116 and the program 118 are modules of computer-executable instructions, which are instructions executable on a computer, computing device, or the processors of a computer. While shown here as modules, the component may be embodied as hardware, software, or any combination thereof. Also, while shown here residing on the computing device 102, the component may be distributed across many computing devices in the distributed system.

The DP compute engine 120 represents the DP-capable computing resources. On a physical level, the DP-capable computing resources include hardware (such as a GPU or SIMD and its memory) that is capable of performing DP tasks. On a logical level, the DP-capable computing resources include the DP computation being mapped to, for example, multiple compute nodes (e.g., 122-136), which perform the DP computations. Typically, each compute node is identical in the capabilities to each other, but each node is separately managed. Like a graph, each node has its own input and its own expected output. The flow of a node's input and output is to/from the non-DP host 110 or to/from other nodes. There may be many host and device compute nodes participating in a program.

A host node typically has one or more general purpose CPUs as well as a single global memory store that may be structured for maximal locality in a NUMA architecture. The host global memory store is supplemented by a cache hierarchy that may be viewed as host-local-memory. When SIMD units in the CPUs on the host are used as a data parallel compute node, then the DP-node is not a device and the DP-node shares host's global and local memory hierarchy.

On the other hand, a GPU or other data parallel coprocessor is a device node with its own global and local memory stores.

The compute nodes (e.g., 122-136) are logical arrangements of DP hardware computing resources. Logically, each compute node (e.g., node 136) is arranged to have its own local memory (e.g., node memory 138) and multiple processing elements (e.g., elements 140-146). The node memory 138 may be used to store values that are part of the node's DP computation and which may persist past one computation.

In some instances, the node memory 138 is separate from the main memory 114 of the non-DP host 110. The data manipulated by DP computations of the compute engine 120 is semantically separated from the main memory 114 of the non-DP host 110. As indicated by arrows 150, values are explicitly copied from general-purpose (i.e., non-DP) data structures in the main memory 114 to and from the aggregate of data associated with the compute engine 120 (which is stored in a collection of local memory, like node memory 138). The detailed mapping of data values to memory locations may be under the control of the system (as directed by the compiler 116), which will allow concurrency to be exploited when there are adequate memory resources.

Each of the processing elements (e.g., 140-146) represents the performance of a DP kernel function (or simply “kernel”). A kernel is a fundamental data-parallel task to be performed. A scalar function is any function that can be executed on the host. A kernel or vector function may be executed on the host, but that is usually completely uninteresting and not useful.

A vector function is a function annotated with _declspec(vector) which requires that it conform to the data parallel programming model rules for admissible types and statements and expressions. A vector function is capable of executing on a data parallel device.

A kernel function is a vector function that is passed to a DP call-site function. The set of all functions that are capable of executing on a data parallel device are precisely the vector functions. So, a kernel function may be viewed as the root of a vector function call-graph.

The kernels operate on an input data set defined as a field. A field is a multi-dimensional aggregate of data of a defined element type. The elemental type may be, for example, an integer, a floating point, Boolean, or any other classification of values usable on the computing device 102.

In this example computer architecture 100, the non-DP host 110 may be part of a traditional single-core central processor unit (CPU) with its memory, and the DP compute engine 120 may be one or more graphical processing units (GPU) on a discrete Peripheral Component Interconnect (PCI) card or on the same board as the CPU. The GPU may have a local memory space that is separate from that of the CPU. Accordingly, the DP compute engine 120 has its own local memory (as represented by the node memory (e.g., 138) of each computer node) that is separate from the non-DP host's own memory (e.g., 114). With the described implementations, the programmer has access to these separate memories.

Alternatively to the example computer architecture 100, the non-DP host 110 may be one of many CPUs or GPUs, and the DP compute engine 120 may be one or more of the rest of the CPUs or GPUs, where the CPUs and/or GPUs are on the same computing device or operating in a cluster. Alternatively still, the cores of a many-core CPU may make up the non-DP host 110 and one or more DP compute engines (e.g., DP compute engine 120).

### Programming Concepts

With the described implementations, the programmer has the ability to use the familiar syntax and notions of a function call of mainstream and traditionally non-DP programming languages (such as C++) to the create DP functionality with DP capable hardware. This means that a typical programmer may write one program that directs the operation of the traditional non-DP optimal hardware (e.g., the non-DP host 110) for any DP capable hardware (e.g., the compute engine 120). At least in part, the executable program 118 represents the program written by the typical programmer and compiled by the compiler 116.

The code that the programmer writes for the DP functionality is similar in syntax, nomenclature, and approach to the code written for the traditional non-DP functionality. More particularly, the programmer may use familiar concepts of passing array arguments for a function to describe the specification of elemental functions for DP computations.

A compiler (e.g., the compiler 116), produced in accordance with the described implementations, handles many details for implementing the DP functionality on the DP capable hardware. In other words, the compiler 116 generates the logical arrangement of the DP compute engine 120 onto the physical DP hardware (e.g., DP-capable processors and memory). Because of this, a programmer need not consider all of the features of the DP computation to capture the semantics of the DP computation. Of course, if a programmer is family with the hardware on which the program may run, that programmer still has the ability to specify or declare how particular operations may be performed and how other resources are handled.

In addition, the programmer may use familiar notions of data set sizes to reason about resources and costs. Beyond cognitive familiarity, for software developers, this new approach allows common specification of types and operation semantics between the non-DP host 110 and the DP compute engine 120. This new approach streamlines product development and makes DP programming and functionality more approachable.

With this new approach, these programming concepts are introduced:
Fields: a multi-dimensional aggregate of data of a pre-defined dimension and element data type.
Index: a multi-dimensional vector used to index into an aggregate of data (e.g., field).
Grid: an aggregate of index instances. Specifically, a grid specifies a multidimensional rectangle that represents all instances of index that are inside the rectangle.
Compute Domain (e.g., grid): an aggregate of index instances that describes all possible parallel threads that a data parallel device may use to execute a kernel.
DP call-site function: the syntax and semantics defined for four DP call-site functions; namely, forall, reduce, scan, and sort.

### Fields

When programming for traditional non-DP hardware, software developers often define custom data structures, such as lists and dictionaries, which contain an application's data. In order to maximize the benefits that are possible from data parallel hardware and functionalities, new data containers offer the DP programs a way to house and refer to the program's aggregate of data. The DP computation operates on these new data containers, which are called “fields.”

A field is the general data array type that DP code manipulates and transforms. It may be viewed as a multi-dimensional array of elements of specified data type (e.g., integer and floating point). For example, a one-dimensional field of floats may be used to represent a dense float vector. A two-dimensional field of colors can be used to represent an image.

More, specifically, let float4 be a vector of 4 32-bit floating point numbers representing Red, Green, Blue and Anti-aliasing values for a pixel on a computer monitor. Assuming the monitor has resolution 1200×1600, then:
field<2, float4>screen(grid<2>(1200, 1600);
   is a good model for the screen.

A field need not be a rectangular grid of definition. Though it is typically defined over an index space that is affine in the sense it is a polygon and polyhedral or a polytope—viz., it is formed as the intersection of a finite number of spaces of the form:

f(x1, x2, xn)>=c

where x1, x2, xn are the coordinates in N-dimensional space and ‘f’ is a linear function of the coordinates.

Fields are allocated on a specific hardware device. Their element type and number of dimension are defined at compile time, while their extents are defined at runtime. In some implementations, a field's specified data type may be a uniform type for the entire field. A field may be represented in this manner: field<N,T>, where N is the number of dimensions of the aggregate of data and T is the elemental data type. Concretely, a field may be described by this generic family of classes:

Pseudocode 1

template<int N, typename element_type>
class field {
public:

field(domain_type & domain);
element_type & operator[ ](const index<N>&);
const element_type& operator[ ](const index<N>&) const;

......

};

Fields are allocated on a specific hardware device basis (e.g., computing device 102). A field's element type and number of dimensions are defined at compile time, while their extents are defined at runtime. Typically, fields serve as the inputs and/or outputs of a data parallel computation. Also, typically, each parallel activity in such a computation is responsible for computing a single element in an output field.

In some of the described techniques, a compiler maps given input data to that which is expected by unit DP computations (i.e., “kernels”) of DP functions. Such kernels may be elementary (cf. infra) to promote safety, productivity and correctness, or the kernels may be non-elemental to promote generality and performance. The user makes the choice (of elemental or non-elemental) depending on design space constraints.

The terminology, used herein, broadcasting and projection or partial projection applies to each parameter of the kernel and corresponding argument (viz., actual) passed to a DP call-site function. If the actual is convertible to the parameter type using existing standard C++ conversion rules, it is known as broadcasting. Otherwise, the other valid conversion is through projection or partial projection. When the parameter type—after removing cv-qualification and indirection—is a scalar type (cf. infra) and the argument/actual is a field whose element type is essentially the same as the scalar type, then projection conversion occurs, which means that every element of the field is acted upon identically by the kernel. When the parameter type—after removing cv-qualification and indirection—is a field of rank M with element type a scalar type (cf. infra) and the argument/actual is a field of rank N of the same element type and N>M, then partial projection conversion occurs and every subset of elements of the field whose indices are the same when projected onto the first M dimensions, but differ in the last N−M dimensions, are acted upon identically by the kernel.

A kernel with only scalar parameters is called an elementary kernel and a DP call-site function is used to pass in at least one field, hence at least one projection conversion occurs. A kernel with a least one parameter that is field is called non-elemental.

An elementary type in the DP programming model may be defined to be one of (by way of example and not limitation):
int, unsigned int
long, unsigned long
long long, unsigned long long (int64==long long)
short, unsigned short
char, unsigned char
bool
float, double

A scalar type of the DP programming model may be defined to be the transitive closure of the elementary types under the ‘struct’ operation. Viz., elementary type and structs of elementary types and structs of structs of elementary types and possibly more elementary types and then structs of structs of structs of . . . etc. In some embodiments, the scalar types may include other types. Pointers and arrays of scalar types may be included as scalar types themselves.

In addition, an elemental function parameter is an instance of a scalar type. A field of scalar element types may be passed to an elemental function parameter when executed at a DP call-site function with the understanding that every element of the field is acted upon identically.

A field may have its element type be a scalar type. A non-elemental function parameter is a field. An argument (or actual) is an instance of a type that is passed to a function call. So an elemental argument is an instance of a scalar type. A non-elemental argument is a field. In one or more implementations of the DP programming model, an elemental type may mean a scalar type and a non-elemental type may mean a field.

In one or more implementations of the DP programming model, an aggregate (i.e., aggregate of data or data set) is a field or pseudo-field. A pseudo-field is a generalization of a field with the same basic characteristics, so that any operation or algorithm performed on a field may also be done on a pseudo-field. Herein, the term “field” includes a ‘field or pseudo-field’—which may be interpreted as a type with field-like characteristics. A pseudo-field (which is the same as an indexable type) may be defined as follows: A pseudo-field is an abstraction of field with all the useful characteristics to allow projection and partial projection to work at DP call-site functions.

In particular a pseudo-field has two primary characteristics:
rank
element type.

In addition a pseudo-field has one or more subscript operators, which by definition are one or more functions of the form:
element_type& operator[ ] (index_expression);
const element type& operator[ ] (index_expression) const;
element_type operator[ ] (index_expression);
const element_type operator[ ] (index_expression) const;
   where index_expression takes the form of one or more of:
index<N>idx
const index<N>idx
index<N>& idx
const index<N>& idx

Next, a pseudo-field has a protocol for projection for partial projection. This protocol is the existence of ‘project’ methods. Viz., Every pseudo-field of rank N, and every 0<=M<N defines a project function of rank M. In this way, if a kernel parameter is a pseudo-field of rank M, then by applying the rank M project function a pseudo-field argument of rank N will implicitly convert to the parameter type.

In addition, a pseudo-field type carries a protocol that allows the generation of code to represent storage in a memory hierarchy. In the case of a GPU, a pseudo-field type has the information useful to create a read-only and a read-write DirectX GPU global memory buffer. In other ISAs (instruction set architectures), there simply needs to information to allow the compiler to specify storage in main memory. A pseudo-field does need not be defined over a grid or an affine index space.

In one embodiment, the protocol to determine storage in the memory hierarchy is the existence of a memory of a specified type:|

IBuffer<element_type>m_buffer;

The existence of a memory whose type is IBuffer<element_type> allows storage in the memory hierarchy to be code generated. An indexable type is simply an alias for a pseudo-field.

### Index

The number of dimensions in a field is also called the field's rank. For example, an image has a rank of two. Each dimension in a field has a lower bound and an extent. These attributes define the range of numbers that are permissible as indices at the given dimension. Typically, as is the case with C/C++ arrays, the lower bound defaults to zero. In order to get or set a particular element in a field, an index is used. An index is an N-tuple, where each of its components fall within the bounds established by corresponding lower bound and extent values. An index may be represented like this: Index<N>, where the index is a vector of size N, which can be used to index a rank N field. A valid index may be defined in this manner:

Pseudocode 2

valid index = { <i₀, ..., i_{N-1}> | where iₖ >=

lower_boundₖ and iₖ < lower_boundₖ + extentₖ }

Please note how this is grid<N>—the vector {lower_boundk} is m_offset and m_extent is {extentk}

### Compute Domain

The compute domain is an aggregate of index instances that describes all possible parallel threads that a data parallel device may use to execute a kernel. The geometry of the compute domain is strongly correlated to the data (viz., fields) being processed, since each data parallel thread makes assumptions about what portion of the field it is responsible for processing. Very often, a DP kernel will have a single output field and the underlying grid of that field will be used as a compute domain. But it could also by a fraction (like 1/16) of the grid, when each thread is responsible for computing 16 output values.

Abstractly, a compute domain is an object that describes a collection of index values. Since the compute domain describes the shape of aggregate of data (i.e., field), it also describes an implied loop structure for iteration over the aggregate of data. A field is a collection of variables where each variable is in one-to-one correspondence with the index values in some domain. A field is defined over a domain and logically has a scalar variable for every index value. Herein, a compute domain may be simply called a “domain.” Since the compute domain specifies the length or extent of every dimension of a field, it may also be called a “grid.”

In a typical scenario, the collection of index values simply corresponds to multi-dimensional array indices. By factoring the specification of the index value as a separate concept (called the compute domain), the specification may be used across multiple fields and additional information may be attached.

A grid may be represented like this: Grid<N>. A grid describes the shape of a field or of a loop nest. For example, a doubly-nested loop, which runs from 0 to N on the outer loop and then from 0 to M on the inner loop, can be described with a two-dimensional grid, with the extent of the first dimension spanning from 0 (inclusive) to N (non-inclusive) and the second dimension extending between 0 and M. A grid is used to specify the extents of fields, too. Grids do not hold data. They only describe the shape of it.

An example of a basic domain is the cross-product of integer arithmetic sequences. An index<N> is an N-dimensional index point, which may also be viewed as a vector based at the origin in N-space. An extent<N> is the length of the sides of a canonical index space. A grid<N> is a canonical index space, which has an offset vector and an extent tuple.

template <int N>

struct grid {

extent<N> m_extent;

index<N> m_offset;

};

Let stride<N> be an alias of extent<N>, then form a strided grid, which is a subset of a grid such that each element idx has the property that for every dimension I, idx[I] is a multiple of some fixed positive integer stride[I]. For example, all points (x, y) where 1<=x<100, 5<=y<55 and x is divisible by 3 and y is divisible by 5, which is equivalent to: dom={(3*x+1,5*y+5)|0<=x<33, 0<=y<10}

Whence:

template <int N>

struct strided_grid : public grid<N> {

stride<N> m_stride;
};

While compute domain formed by a strided_grid seems to be more general than a canonical index space, it really is not. At a DP call-site function, a change of variable can always map a strided_grid compute domain back to a grid compute domain. Let dom2={(x,y)|0<=x<33, 0<=y<10}, and form the kernel:

_{——}declspec(vector)

void k(index<2> idx,

field<2,float> c,
read_only< field<2,float>> a,
read_only< field<2,float>> b) {

int i = idx[0];
int j = idx[1];
c(i,j) = a(i−1,j) + b(i, j+1);

}

Then (be sure to look at the whole comment . . . ) forall(dom, k, c, a, b); Is equivalent to: forall(dom2, k2, c, a, b); where

void k2(index<2> idx,

field<2,float> c,

read_only< field<2,float>> a,
read_only< field<2,float>> b) {

int i = idx[0];
int j = idx[1];

c(3*i+1,5*j+5) = a(3*i,5*j+5) +

b(3*i+1, 5*j+6);

}

With this, varieties of constructors have been elided and are specialization specific. The rank or dimensionality of the domain is a part of the type so that it is available at compile time.

A compute domain is an index space. The formal definition of index space:
An affine space is a polytope is a geometric object that is a connected and bounded region with flat sides, which exists in any general number of dimensions. A 2-polytope is a polygon, a 3-polytope is a polyhedron, a 4-polytope is a polyclioron, and so on in higher dimensions. If the bounded requirement is removed then the space is known as an apeirotope or a tessellation.
An index point is a point in N-space {i₀, i₁, . . . iₙ₋₁} where each iₖ is a 32-bit signed integer.
An index space is the set of all index points in an affine space. A general field is defined over an index space, viz., for every index point in the index space, there is an associated field element.
A canonical index space is an index space with sides parallel to the coordinate exes in N-space. When the DP programming model compute device is a GPU, before computing a kernel, every field's index space may be transformed into a canonical index space.

For some dimension N>0, work in the context of N-space, viz., all N-dimensional vector with coefficients in the real numbers. On a computer, a float or a double is simply an approximation of a real number. Let index<N> denote an index point (or vector) in N-space. Let extent<N> denote the length of the sides of a canonical index space. Let grid<N> denote a canonical index space which is an extent for the shape and a vector offset for position—hence:

template <int N>
struct grid {

extent<N> m_extent;

index<N> m_offset;

};

Let field<N, Type> denote an aggregate of Type instances over a canonical index space. Specifically, given a: grid<N>g(_extent, _offset), then field<N, Type>f(g), it associates for each index point in g a unique instance of type. Clearly, this is an abstraction of a DP programming model array (single or multi-dimensional).

However, a compute domain is an index space, which is not necessarily canonical. Looking further on, define a loop nest to be a single loop whose body contain zero, one or more loops—called child loops—and each child loop may contain zero, one or more loops, etc. . . . . The depth of loop containment is called the rank of the loop nest. E.g.

for (int i...) {

int x = a[i]+b[i];

foo(x−5);
for (int j...)

goo(i+j);

}

is a loop nest of rank 2.

### Resource View

A resource_view is represents a data parallel processing engine on a given compute device. A compute_device is an abstraction of a physical data parallel device. There can be multiple resource_view on a single compute_device. In fact, a resource_view may be viewed as a data parallel thread of execution.

If a resource_view is not explicitly specified, then a default one may be created. After a default is created, all future operating system (OS) threads on which a resource view is implicitly needed, will get the default previously created. A resource_view can be used from different OS threads.

Also with this new approach, a resource view allows concepts, such as priority, deadline scheduling, and resource limits, to be specified and enforced within the context of the compute engine 120. Domain constructors may optionally be parameterized by a resource view. This identifies a set of computing resources to be used to hold aggregate of data and perform computations. Such resources may have private memory (e.g., node memory 138) and very different characteristics from the main memory 114 of the non-DP host 110. As a logical construct, the computer engine refers to this set of resources. Treated herein simply as an opaque type:

Pseudocode 3

typedef ... resource_view;

In addition:

class compute_device;
compute_device device = get_reference_device(D3D11_GPU);

This specifies the physical compute node that data parallel work will be scheduled on. Then

class resource_view;
compute_device device = get_reference_device(D3D11_GPU);

resource_view rv = device.get_default_resource_view( );

is an abstraction of a scheduler on a compute device. A resource_view instance may be accessed from multiple threads and more than one resource_view, even in different processes, may be created for a given compute_device.

### DP Call-Site Functions

With this new approach, a DP call-site function call may be applied to aggregate of data associated with DP capable hardware (e.g., of the compute engine 120) to describe DP computation. The function applied is annotated to allow its use in a DP context. Functions may be scalar in nature in that they are expected to consume and produce scalar values, although they may access aggregate of data. The functions are applied elementally to at least one aggregate of data in a parallel invocation. In a sense, functions specify the body of a loop, where the loop structure is inferred from the structure of the data. Some parameters to the function are applied to just elements of the data (i.e., streaming), while aggregate of data may also be passed like arrays for indexed access (i.e., non-streaming).

A DP call-site function applies an executable piece of code, called a kernel, to every virtual data parallel thread represented by the compute domain. This piece of code is called the “kernel” and is what each processing element (e.g., 140-146) of a compute node executes.

Described herein are implementations of four different specific DP call-site functions that represent four different DP primitives: forall, reduce, scan, and sort. The first of the described DP call-site functions is the “forall” function. Using the forall function, a programmer may generate a DP nested loop with a single function call. A nested loop is a logical structure where one loop is situated within the body of another loop. The following is an example pseudocode of a nested loop:

Pseudocode 4

for (int i=0; i<N; i++)

for (int j=0; j<=i; j++)

x(i,j) = foo(y(i,j), z(i,j));
...

In a traditional serial execution of the above nested loop, the first iteration of the outer loop (i.e., the i-loop) causes the inner loop (i.e., the j-loop) to execute. Consequently, the example nested function “foo(y(i,j), z(i,j))”, which is inside the inner j-loop, executes serially j times for each iteration of the i-loop. Instead of a serial execution of a nested loop code written in a traditional manner, the new approach offers a new DP call-site function called “forall” that, when compiled and executed, logically performs each iteration of the nested function (e.g., “foo(y(i,j), z(i,j))”) in parallel (which is called a “kernel”).

A loop nest is a single loop whose body contain zero, one or more loops—called child loops—and each child loop may contain zero, one or more loops, etc. . . . . The depth of loop containment is called the rank of the loop nest. E.g.

for (int i...) {

int x = a[i]+b[i];

foo(x−5);
for (int j...)

goo(i+j);

}

is a loop nest of rank 2. The most inner loop in a loop nest is called the leaf (In the example the body of the leaf loop is goo(i+j);)

An affine loop nest is a loop nest where the set of all loop induction variables forms an (affine) index space.

A perfect loop nest is an affine loop nest for which every non-leaf loop body contains precisely one loop and no other statements. E.g.

for (int i...) {

for (int j...) {

int x = a[i]+b[j];
foo(x−5);
goo(i+j);

}

}

An affine loop nest is pseudo-perfect if for some N, the first N-loops form a perfect loop nest and N is the rank. E.g.

for (int i = 1; i < 100; ++i) {

for (int j = −5; j < 50; ++j) {

int x = a[i]+b[i][j];
foo(x−5);
for (int k...)

goo(i+j+k);

for (int k...)

foo(k−x);

}

}

This forms a pseudo-perfect loop nest of rank 2. Clearly, every affine loop nest is pseudo-perfect of rank at least 1.

In the DP programming model, a pseudo-perfect loop nest maps directly to a compute domain. E.g. in the above example, form the compute domain ‘dom’ of all index points in:

{ (x,y) | 1 <= x < 100, −5 <= y < 50 }

grid<2> dom(extent<2>(99,55),index<2>(1,−5));
Let the kernel be :

_{——}declspec(vector)
void k(index<2> idx,

field<1, double> a,
field<2, float> b) {

int i = idx[0];
int j = idx[1];
int x = a(i)+b(i, j);
foo(x−5);
for (int k...)

goo(i+j+k);

for (int k...)

foo(k−x);

}

Then the above pseudo-perfect loop nest is equivalent to: forall(dom, k, a, b);

A perfect loop nest is a collection of loops such that there is a single outer loop statement and the body of every loop is either exactly one loop or is a sequence of non-loop statements. An affine loop nest is a collection of loops such that there is a single outer loop statement and the body of every loop is a sequence of possible-loop statements. The bounds of every loop in an affine loop are linear in the loop induction variables.

At least one implementation of the DP call-site function forall is designed to map affine loop nests to data parallel code. Typically, the portion of the affine loop nest starting with the outer loop and continuing as long as the loop next are perfect, is mapped to a data parallel compute domain and then the remainder of the affine nest is put into the kernel.

A pseudocode format of the forall function is shown here:

Pseudocode 5

template<typename index_domain,typename kernelfun,

typename Fields... >

void forall(index_domain d,

kernelfun foo,
Field... fields) { ... }

The basic semantics of this function call will evaluate the function “foo” for every index specified by domain “d” with arguments from corresponding elements of the fields, just as in the original loop.

This is an alternative format of the pseudocode for the forall function:

Pseudocode 6

grid<2> cdomain(height, width);
field<2, double> X(cdomain), Y(cdomain), Z(cdomain);
forall(cdomain,

[=] _{——}declspec(vector) (double &x,

double y,
double z ) {

x = foo(y,z);

}, X, Y, Z);

In the example pseudocode above, the forall function is shown as a lambda expression, as indicated by the lambda operator “=”. A lambda expression is an anonymous function that can construct anonymous functions of expressions and statements, and can be used to create delegates or expression tree types.

In addition, the effect of using by-value to modify double “y” and “z” has benefit. When a programmer labels an argument in this manner, it maps the variable to read-only memory space. Because of this, the program may execute faster and more efficiently since the values written to that memory area maintain their integrity, particularly when distributed to multiple memory systems. One embodiment indicates read-only by having elemental parameter pass by-value. And a field or pseudo-field (generalized field) parameter is modified by a read_only operator appearing in its type descriptor chain. And read-write is indicated for an elemental parameter as pass by-reference. And a field or pseudo-field parameter without the read_only operator appearing in its type descriptor chain is also read-write.

Another embodiment indicates read-only by having elemental parameter pass by-value. And a field or pseudo-field (generalized field) parameter is modified by a const modifier (sometimes called a cv-qualifier, for ‘const’ and ‘volatile’ modifiers). And read-write is indicated for an elemental parameter as pass by-reference. And a field or pseudo-field parameter without the const modifier is also read-write. Therefore, using this “const” label or another equivalent label, the programmer can increase efficiency when there is no need to write back to that memory area.

Another of the specific DP call-site functions described herein is the “reduce” function. Using the reduce function, a programmer may compute the sum of very large arrays of values. A couple of examples of pseudocode format of the reduce function are shown here:

Pseudocode 7

typename <

typename domain_type,
typename reducefunc,
typename result_type,
typename kernelfunc,
typename... Fields>

void reduce (domain_type d,

reducefunc r,
result_type& result,
kernelfunc f,
Fields... fields) { ... }

typename <

unsigned dim,
unsigned rank,
typename reducefunc,
typename result_type,
typename kernelfunc,
typename... Fields>

void reduce (grid<rank> d,

reducefunc r,
field<grid<rank−1>, result_type>

result,

kernelfunc f,

Fields... fields) { ... }

In general, the first reduce function maps with ‘kernelfun f’ the variadic argument ‘fields’ into a single field of element type result_type, which is then reduced with ‘reducefun r’ into a single instance of result_type.

The second reduce function maps with ‘kernelfun f’ the variadic argument ‘fields’ into a single field of rank ‘rank’ and element type ‘result_type’, which is then reduced in the dim direction with ‘reducefun r’ into a single rank-1ifield of result_type.

A ‘pencil’ may be thought of in this way: For every rank-1 dimensional index point formed by ignoring the contribution of the slot at dim (viz., index<N>idx can be viewed as an element of index<N−1> by ignoring the contribution of the slot dim. E.g. index<3> idx and dim=1, then idx<2> (idx[0], idx[2]) is the index point obtained by ignoring slot dim=1), then let the values at slot dim vary. Example: field<3, float>f(grid<3>(10,20,30));

A pencil is formed in the dim=1 direction. For each 0<=x0<10 and 0<=z0<30 consider the 1-D sub-field (viz., pencil): consisting of all points f(x0, y, z0) where 0<=y<20. Specifically such a sub-field is called pencil at {x0, 0, z0) in the dim direction.

The terminology ‘reduced in the dim direction’ means that for every rank-1 dimensional index point obtained by ignoring the contribution of slot dim, form the pencil in the dim direction. Then reduce the pencil to a instance of result_type by using ‘reducefun r’. Example: field<3, float> f(grid<3>(10,20,30)); Reduce in the dim=1 direction.

For each 0<=x0<10 and 0<=z0<30 consider the pencil consisting of all points f(x0, y, z0) where 0<=y<20. Use ‘reducefun r’ to reduce all such points to a single value (x0, result, z0)—result does depend upon x0 and z0. Now put it all back together which yields: field<2, float> reduce_result(grid<2>(10, 30)); Formed by letting x0 and z0 vary through their domain of definition.

Function “r” combines two instances of this type and returns a new instance. It is assumed to be associative and commutative. In the first case, this function is applied exhaustively to reduce to a single result value stored in “result”. This second form is restricted to “grid” domains, where one dimension is selected (by “dim”) and is eliminated by reduction, as above. The “result_field” input value is combined with the generated value via the function “r”, as well. For example, this pattern matches matrix multiply-accumulate: A=A+B*C, where the computation grid corresponds to the 3-dimensional space of the elemental multiples.

Still another of the specific DP call-site functions described herein is the “scan” function. The scan function is also known as the “parallel prefix” primitive of data parallel computing. Using the scan function, a programmer may, given an array of values, compute a new array in which each element is the sum of all the elements before it in the input array. An example pseudocode format of the scan function is shown here:

Pseudocode 8

template<

typename domain_type,
unsigned dim,
typename reducefunc,
typename result_type,
typename kernelfunc,
typename... Fields>

void scan(

domain_type d,
reducefunc r,
field<domain_type,result_type> result,
kernelfunc f,

Fields... fields) { ... }

As in the reduction case, the “dim” argument selects a “pencil” through that data. A “pencil” is a lower dimensional projection of the data set. In particular, map with ‘kernelfunc f’ the variadic argument ‘fields’ into a single field of the same rank as ‘domaintype d’ and element type ‘result_type’. Then for each rank-1 dimensional index point obtained by ignoring the contribution of slot dim, form the pencil in the dim direction. Then perform the scan (viz., parallel prefix) operation on the pencil to yield another pencil, the aggregation of which yields ‘result’.

See the following for more information about scan or parallel prefix: G. E. Blelloch, “Scans as Primitive Parallel Operations,” IEEE Transactions on Computers, vol. 38, no. 11, pp. 1526-1538, November, 1989.

Intuitively scan is the repeated application of the ‘scanfunc s’ to a vector. Denote ‘scanfunc s’ as an associative binary operator, so that s(x, y)=x y. Then

scan<>(x0, x1, xn)=(x0, x0 x1, x0 x1 x2, . . . , x0 x1 . . . xn)

For example, consider a two-dimensional matrix of extents 10×10. Then, a pencil would be the fifth column. Or consider a three-dimensional cube of data, then a pencil would be the xz-plane at y=y0. In the reduction case, that pencil was reduced to a scalar value, but here that pencil defines a sequence of values upon which a parallel prefix computation is performed using operator “r,” here assumed to be associative. This produces a sequence of values that are then stored in the corresponding elements of “result.”

The last of the four specific DP call-site functions described herein is the “sort” function. Just as the name implies with this function, a programmer may sort through a large data set using one or more of the known data parallel sorting algorithms. The sort function is parameterized by a comparison function, a field to be sorted, and additional fields that might be referenced by the comparison. An example pseudocode format of the sort function is shown here:

Pseudocode 9

template<

typename domain_type,
unsigned dim,
typename record_type,
typename... Fields>

void sort(

domain_type d,
int cmp(record_type&, record_type&),
field<domain_type,record_type> sort_field,

Fields... fields) { ... }

As above, this sort operation is applied to pencils in the “dim” dimension and updates “sort_field” in its place.

### Other Programming Concepts

Based upon the arguments of a DP call-site, the DP call-site function may operate on two different types of input parameters: elemental and non-elemental. Consequently, the compute nodes (e.g., 122-136), generated based upon the DP call-site, operate on one of those two different types of parameters.

With an elemental input, a compute node operates upon a single value or scalar value. With a non-elemental input, a compute node operates on an aggregate of data or a vector of values. That is, the compute node has the ability to index arbitrarily into the aggregate of data. The calls for DP call-site functions will have arguments that are either elemental or non-elemental. These DP call-site calls will generate logical compute nodes (e.g., 122-136) based upon the values associated with the function's arguments.

In general, the computations of elemental compute nodes may overlap but the non-elemental computer nodes typically do not. In the non-elemental case, the aggregate of data may be fully realized in the compute engine memory (e.g., node memory 138) before any node accesses any particular element in the aggregate of data. One of the advantages, for example, of elemental is that the resulting DP computation cannot have race conditions, dead-locks or live locks—all of which are the results of inter-dependencies in timing and scheduling. An elemental kernel is unable to specify ordering or dependencies and hence is inherently concurrency safe.

For the DP call-site functions, it is not necessary that kernel formal parameter types match the actual types of the arguments passed in. Assume the type of the actual is a field of rank Ra and the compute domain has rank Rc.
1. If the type of the formal is not a field, but is the same type (modulo const and reference) as the element type of the actual field, then there is a valid conversion whenever:

Rₐ=R_{c}
2. If the type of the formal is a field (modulo const and reference) of rank R_{f}, then there is a valid conversion whenever:

Rₐ=R_{f}+R_{c}.
3. To be complete, there is the identity conversion, where the formal and actual types match:

Rₐ=R_{f}

In another embodiment (which will be labeled “conversion 2.5” since it replaced #2 above), if the type of the formal is a field (modulo const and reference) of rank Rf, then there is a valid conversion whenever:

Ra>Rf

and

Ra<Rf+Rc

This is like #2 above. One fills up all access to the actual (from left-to-right) first with the indices from the formal and then put in as many indices from the compute domain as fit. The indices from the right in the compute domain are used first, so that unit stride compute domain access is always used. The difference between this and #2 is that in @2 all the indices from the compute domain are used where in 2.5 only those indices needed are used.)

As an example to illustrate conversion 1, known as elemental projection, consider vector addition with kernel:

_{——}declspec(vector)

void vector_add(double& c, double a, double b)
c = a + b;
}

The actuals for the DP call-site function are:

grid domain(1024, 1024);

field<2, double> A(domain), B(domain), C(domain);

Then a call-site takes the form:

forall(C.get_grid( ), vector_add, C, A, B);

The following conversions:

C −> double& c
A −> double a
B −> double b

work by treating the whole of the field aggregates exactly the same in the kernel vector_add. In other words, for every two indices:

index<2>idx1, idx2

in domain, C[idx1] and C[idx2] (resp., A[idx1] and A[idx2], B[idx1] and B[idx2]) are treated identically in the kernel vector_add.

These conversions are called elemental projection. A kernel is said to be elemental if it has no parameter types that are fields. One of the advantages of elemental kernels includes the complete lack of possible race conditions, dead-locks or live-locks, because there is no distinguishing between the processing of any element of the actual fields.

As an example to illustrate conversion 2, known as partial projection, consider vector addition with kernel:

Pseudocode 10

_{——}declspec(vector)

void sum_rows(double& c, const field<1, double>& a) {

int length = a.get_extents(0);
// create a temporary so that a register is accessed
// instead of global memory
double c_ret = 0.0;
// sum the vector a
for (int k = 0; k < length; ++k)

c_ret += a(k);

// assign result to global memory
c = c_ret;

}

The actuals for the DP call-site function are:

grid domain(1024, 1024), compute_domain(1024);
field<2, double> A(domain), C(comput_domain);

Then a call-site takes the form:

forall(C.get_grid( ), sum_rows, C, A);

Of the following conversions:

C -> double& c
A -> const field<1, double>& a,

As an example to illustrate conversion 2.5, known as redundant partial projection, consider a slight modification of the sum_rows kernel used to illustrate conversion 2:

```
_{—}
_declspec(kernel)
    void sum_rows2(double& c, const field<1, double>& a) {
    int length = a.get_extents(0);
    // create a temporary so that a register is accessed
    // instead of global memory
    double c_ret = 0.0;
    // sum the vector a
    for (int k = 0; k < length; ++k)
        c_ret += a(k);
    // assign result to global memory
    c += c_ret; // c is in-out
}
```

And now the actuals are

grid domain(1024, 1024);
field<2, double> A(domain), C(domain);

Then a call-site takes the form: forall(C.get_grid( ), sum_rows2, C, A);

Of the following conversions:

C -> double& c
A -> const field<1, double>& a,

The first one is elemental projection covered above in conversion 1. For the second one, the left index of elements of A are acted on by the kernel sum_rows, while the compute domain fills in the right index. In other words, for a given ‘index<2>idx’ in compute domain, the body of sum_rows takes the form:

```
int length = a.get_extents(0);
    // create a temporary so that a register is accessed
    // instead of global memory
  double c_ret = 0.0;
    // sum the vector a
  for (int k = 0; k < length; ++k)
      c_ret += a(k, idx[0]);
    // assign result to global memory
    C[idx]+ = c_ret;
```

The main difference between 2 and 2.5 is that in 2.5 the compute domain is 2-dimensional so that: Ra<Rf+Rc; Or 2<3. Otherwise 2.5 has the same advantages as 2. But 2.5 is more general than 2.

The first one is elemental projection covered above in conversion 1. For the second one, the left index of elements of A are acted on by the kernel sum_rows, while the compute domain fills in the right index. In other words, for a given ‘index<1>idx’ in compute domain, the body of sum_rows takes the form:

```
    int length = a.get_extents(0);
// create a temporary so that a register is accessed
//  instead of global memory
double c_ret = 0.0;
// sum the vector a
      for (int k = 0; k < length; ++k)
    c_ret += a(k, idx[0]);
      // assign result to global memory
      C[idx] = c_ret;
```

This is called partial-projection and one of the advantages includes that there is no possibility of common concurrency bugs in the indices provided by the compute domain. Note the general term projection covers elemental projection and partial projection and redundant partial projection. The general form of partial projection is such that the farthest right ‘Rf’ number of indices of the elements of A are acted on by the kernel with the rest of the indices filled in by the compute domain, hence the requirement:

Rₐ=R_{f}+R_{c}.

As a slightly more complex example of conversion, consider:

Pseudocode 11

```
    _declspec(vector)
    void sum_dimensions(double& c, const field<Rank_f, double>& a)
{
        double c_ret = 0.0;
        for (int k0 = 0; k0 < a.get_extents(0); ++k0)
            for (int k1 = 0; k1 < a.get_extents(1); ++k1)
                .....
                for (int kf = 0; kf < a.get_extents(Rank_f − 1);
++kf)
                    c_ret += a(k0, k1, ..., kf);
        c = c_ret;
    }
```

With actuals:

const int N, Rank_f;
int extents1[N], extents2[N+Rank_f];
grid domain(extents2), compute_domain(extents1);
field<2, double> A(domain), C(comput_domain);

Then a call-site takes the form:

forall(C.get_grid( ), sum_dimensions, C, A);

For the following conversion:

A -> const field<rank_f, double>& a,

One interpretation of the body of the kernel includes:

Pseudocode 12

```
        Let index<N> idx;
        i0 = idx[0];
        i1 = idx[1];
        ...
        iN = idx[N−1]
        double c_ret = 0.0;
        for (int k0 = 0; k0 < a.get_extents(0); ++k0)
            for (int k1 = 0; k1 < a.get_extents(1); ++k1)
                .....
                for (int kf = 0; kf < a.get_extents(Rank_f − 1);
++kf)
                    c_ret += a(k0, k1, ..., kf, i0, i1, ..., iN−1);
        c(i0, i1, ..., iN−1) = c_ret;
```

A slightly more complex example is matrix multiplication using the communication operators transpose and spread.

Given ‘field<N, T>A, transpose<i, j>(A) is the result of swapping dimension i with dimensions j. For example, when N=2, transpose<0,1>(A) is normal matrix transpose: transpose<0,1>(A)(i,j)→A(j,i).

On the other hand, spread<i>(A), is the result of adding a dummy dimension at index i, shifting all subsequent indices to the right by one. For example, when N=2, the result of spread<1>(A) is a three dimensional field where the old slot-0 stays the same, but the old slot-1 is moved to slot-2 and slot-1 is a dummy: spread<1>(A)(i, j, k)=A(i, k).

Using the kernel:

Pseudocode 13

```
_declspec(vector)
void inner_product(float& c,
            const field<1, float>& a,
            const field<1, float>& b) {
    double c_ret = 0.0;
    for (int k = 0; k < a.get_extents(0); ++k)
        c_ret += a(k)*b(k);
    c = c_ret;
}
```

With actuals:

grid domain(1024, 1024);
field<2, double> C(domain), A(domain), B(domain);

Then matrix multiplication is the following DP call-site function:

Pseudocode 14

```
  forall(C.grid( ), inner_product, C,
    // spread<2>(transpose(A))(k,i,j) -> transpose(A)(k,i) -
> (i,k)
    spread<2>(transpose(A)),
    // spread<1>(B)(k,i,j) -> (k,j)
    spread<1>(B));
```

The inner_product kernel acts on A and B at the left-most slot (viz., k) and the compute domain fills in the two slots in the right. Essentially spread is simply used to keep the index manipulations clean and consistent. Moreover, spread may be used to transform conversion 2.5 to conversion 2. In that sense 2.5 is only more general in that it does not require unnecessary spread shenanigans and hence makes the programming model easier.

One last example for partial projection uses the DP call-site function ‘reduce’ to compute matrix multiplication.

Take, for example, the following:

Pseudocode 15

```
  reduce<1>(grid<3>(
      // i, j, k
      c.grid(0),c.grid(1),a.grid(1)),
      // transform that performs the actual reduction
      [=](double x, double y)->double{ return x + y; },
      // target
      c,
      // map
      [=](double x, double y)->double{ return x  y; },
      // spread<1>(a)(i,j,k) => i,k
      spread<1>(a),
      // spread<0>(transpose(b))(i,j,k) =>
transpose(b)(j,k) => (k,j))
    spread<0>(transpose(b));
```

Since reduce operates on the right-most indices, the use of transpose and spread is different from before. The interpretation is that reduce<1> reduces the right-most dimension of the compute domain.

The two functions (viz., lambdas) are used analogously to map-reduce:

```
  map: { {x0, y0}, {x1, y1}, ..., {xN, yN} } => { map(x0,y0),
map(x1, y1), ..., map(xN, yN) };
  reduce: => transform(map(x0, y0), transform(map(x1, y1),
transform(... , map(xN, yN))...));
```

### Or:

Pseudocode 16

```
  map: { {x0, y0}, {x1, y1}, ..., {xN, yN} } => { x0*y0, x1*y1,
..., xN*yN };
  reduce: => x0*y0 + x1*y1 + ... + xN*yN;
```

As an example illustrating conversion 3, let N=K+M and consider:

Pseudocode 17

```
  _declspec(vector)
  void sum_dimensions(const index<K>& idx,
          field<K, double>& c,
              const field<N, double>& a) {
    double c_ret = 0.0;
    for (int k₀ = 0; k₀ < a.get_extents(0); ++k₀)
      for (int k₁ = 0; k₁ < a.get_extents(1); ++ k₁)
        .....
        for (int k_{M-1} = 0; k_{M-1} < a.get_extents(M − 1);
++k_{M-1})
            c_ret += a(k₀, k₁, ..., k_{M-1}, idx[0], idx[1],
..., idx[K−1]);
    c[idx] = c_ret;
  }
```

Pseudocode 18

const int K, M, N; // N = K + M
int extents1[K], extents2[N];
grid domain(extents2), compute_domain(extents1);
field<2, double> A(domain), C(compute_domain);

Then a call-site takes the form:

forall(C.get_grid( ), sum_dimensions, C, A);

And, in this case, these conversions are identity conversions.

When creating memory on the device, it starts raw and then may have views that are either read-only or read-write. One of the advantages of read-only includes that when the problem is split up between multiple devices (sometimes called an out-of-core algorithm), read-only memory does not need to be checked to see if it needs to be updated. For example, if device 1 is manipulating chunk of memory, field 1, and device 2 is using field 1, then there is no need for device 1 to check whether field 1 has been changed by device 2. A similar picture holds for the host and the device using a chunk of memory as a field. If the memory chunk is read-write, then there would need to be a synchronization protocol between the actions on device 1 and device 2.

When a field is first created, it is just raw memory and it is not ready for access; that is it does not have a ‘view’ yet. When a field is passed into a kernel at a DP call-site function, the signature of the parameter type determines whether it will have a read-only view or a read-write view (there can be two views of the same memory.

A read-only view will be created if the parameter type is by-value or const-by-reference, viz., for some type ‘element type’. Embodiment 1:
a) Elemental read-only parameter has scalar type and is pass-by-value
b) Non-elemental read-only parameter is of type read_only<T> where T is either a specific field type or it is generic.
c) Elemental read-write parameter has scalar type and is pass-by-reference.
d) Non-elemental read-write parameter is of type T where T is either a specific field type or it is generic.

### Embodiment 2

a) Elemental read-only parameter has scalar type and is pass-by-value
b) Non-elemental read-only parameter is of type const T or const T& where T is either a specific field type or it is generic.
c) Elemental read-write parameter has scalar type and is pass-by-reference.
d) Non-elemental read-write parameter is of type T or T& where T is either a specific field type or it is generic.

Pseudocode 19

```
element_type x
  field<N, element_type> y
  const field<N, element_type>& z
read_only_field<field<2, element_type>> w
```

Note that read_only_field<rank, element_type> is simply an alias for read_only<field<rank, element_type>>.

A read-write view will be created if the parameter type is a non-const reference type:

element_type& x
field<N, element_type>& y.

A field can be explicitly restricted to have only a read-only view, where it does not have a read-write view, by using the communication operator:

read_only.

The read_only operator works by only defining const modifiers and index operators and subscript operators and hence:

read_only(A)

is used in a way that causes a write. In particular, if passed into a kernel (through a DP call-site function), a compiler error may occur.

For example, in one embodiment, the distinction would be between:

```
element_type x
  field<N, element_type> y
  const field<N, element_type>& z
```

and

Pseudocode 20

element_type& x
field<N, element_type>& y.

While in another embodiment, the distinction would be between:

element_type x
read_only_field<field<2, element_type>> w

and

element_type& x
field<N, element_type> y.

The first embodiment uses by-val vs. ref and const vs. non-const to distinguish between read-only vs. read-write. The second embodiment uses by-val vs. ref only for elemental formals, otherwise for field formals it uses read_only_field vs. field to distinguish between read-only vs. read-write. The reasoning for the second is that reference is really a lie when the device and host have different memory systems.

### Example Processes

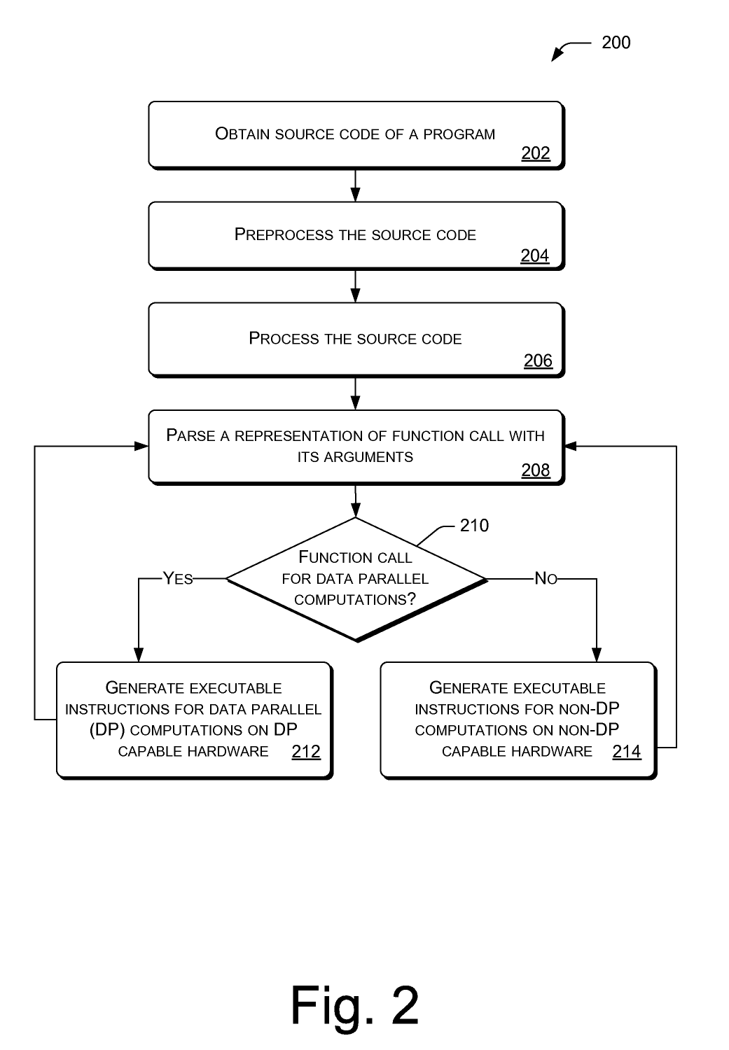

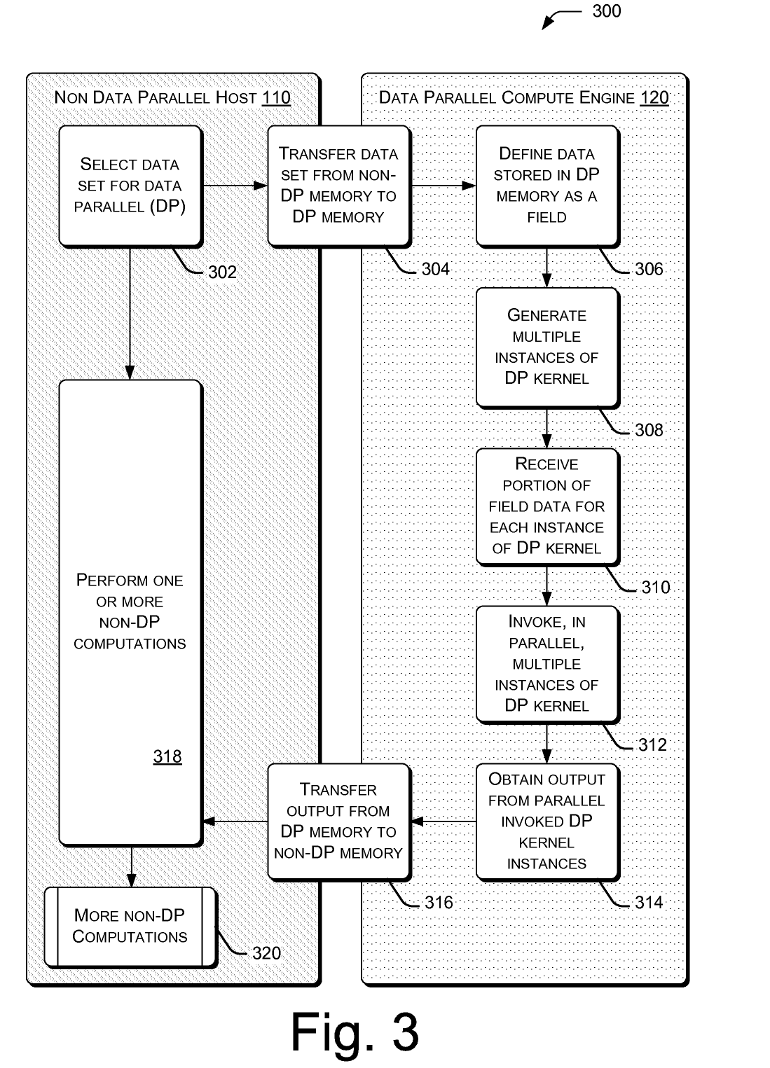

FIGS. 2 and 3 are flow diagrams illustrating example processes 200 and 300 that implement the techniques described herein. The discussion of these processes will include references to computer components of FIG. 1. Each of these processes is illustrated as a collection of blocks in a logical flow graph, which represents a sequence of operations that can be implemented in hardware, software, firmware, or a combination thereof. In the context of software, the blocks represent computer instructions stored on one or more computer-readable storage media that, when executed by one or more processors of such a computer, perform the recited operations. Note that the order in which the processes are described is not intended to be construed as a limitation, and any number of the described process blocks can be combined in any order to implement the processes, or an alternate process. Additionally, individual blocks may be deleted from the processes without departing from the spirit and scope of the subject matter described herein.

FIG. 2 illustrates the example process 200 that facilitates production of programs that are capable of executing on DP capable hardware. That production may be, for example, performed by a C++ programming language compiler. The process 200 is performed, at least in part, by a computing device or system which includes, for example, the computing device 102 of FIG. 1. The computing device or system is configured to facilitate the production of one or more DP executable programs. The computing device or system may be either non-DP capable or DP capable. The computing device or system so configured qualifies as a particular machine or apparatus.

As shown here, the process 200 begins with operation 202, where the computing device obtains a source code of a program. This source code is a collection of textual statements or declarations written in some human-readable computer programming language (e.g., C++). The source code may be obtained from one or more files stored in a secondary storage system, such as storage system 106.

For this example process 200, the obtained source code includes a textual representation of a call for a DP call-site. The textual representation includes indicators of arguments that are associated with the call for the DP call-site. The function calls from pseudocode listings 8-11 above are examples of a type of the textual representation contemplated here. In particular, the forall, scan, reduce, and sort function calls and their argument of those listings are example textual representations. Of course, other formats of textual representations of function calls and arguments are contemplated as well.

At operation 204, the computing device preprocesses the source code. When compiled, the preprocessing may include a lexical and syntax analysis of the source code. Within the context of the programming language of the compiler, the preprocessing verifies the meaning of the various words, numbers, and symbols, and their conformance with the programming rules or structure. Also, the source code may be converted into an intermediate format, where the textual content is represented in a object or token fashion. This intermediate format may rearrange the content into a tree structure. For this example process 200, instead of using a textual representation of the call for a DP call-site function (with its arguments), the DP call-site function call (with its arguments) may be represented in the intermediate format.

At operation 206, the computing device processes the source code. When compiled, the source-code processing converts source code (or an intermediate format of the source code) into executable instructions.

At operation 208, the computing device parses each representation of a function call (with its arguments) as it processes the source code (in its native or intermediate format).

At operation 210, the computing device determines whether a parsed representation of a function call is a call for a DP computation. The example process 200 moves to operation 212 if the parsed representation of a function call is a call for a DP computation. Otherwise, the example process 200 moves to operation 214. After generating the appropriate executable instructions at either operation 212 or 214, the example process returns to operation 208 until all of the source code has been processed.

At operation 212, the computing device generates executable instructions for DP computations on DP capable hardware (e.g., the DP compute engine 120). The generated DP executable instructions include those based upon the call for the DP call-site function with its associated arguments. Those DP call-site function instructions are created to be executed on a specific target DP capable hardware (e.g., the DP compute engine 120). In addition, when those DP-function instructions are executed, a data set is defined based upon the arguments, with that data set being stored in a memory (e.g., node memory 138) that is part of the DP capable hardware. Moreover, when those DP-function instructions are executed, the DP call-site function is performed upon that data set stored in the DP capable memory.

At operation 214, the computing device generates executable instructions for non-DP computations on non-DP optimal hardware (e.g., the non-DP host 110).

After the processing, or as part of the processing, the computing device links the generated code and combines it with other already compiled modules and/or run-time libraries to produce a final executable file or image.

FIG. 3 illustrates the example process 300 that facilitates the execution of DP executable programs in DP capable hardware. The process 300 is performed, at least in part, by a computing device or system which includes, for example, the computing device 102 of FIG. 1. The computing device or system is configured to execute instructions on both non-DP optimal hardware (e.g., the non-DP host 110) and DP capable hardware (e.g., the DP compute engine 120). Indeed, the operations are illustrated with the appropriate hardware (e.g., the non-DP host 110 and/or the compute engine 120) that executes the operations and/or is the object of the operations. The computing device or system so configured qualifies as a particular machine or apparatus.

As shown here, the process 300 begins with operation 302, where the computing device selects a data set to be used for DP computation. More particularly, the non-DP optimal hardware (e.g., non-DP host 110) of the computing device selects the data set that is stored in a memory (e.g., the main memory 114) that is not part of the DP capable hardware of one or more of the computing devices (e.g., computing device 102).

At operation 304, the computing device transfers the data of the selected data set from the non-DP memory (e.g., main memory 114) to the DP memory (e.g., the node memory 128). In the case that the DP-optimal hardware are SIMD units in general CPUs or other non-device DP-optimal hardware, DP-memory and non-DP memory are the same. Hence, there is never any need to copy between DP-memory and non-DP-memory.

In the case that the DP-optimal hardware is GPU or other device DP-optimal hardware, DP-memory and non-DP memory are completely distinct. Hence, there is a need to copy between DP-memory and non-DP-memory. Though such copies should be minimized to optimize performance, viz., keep memory for computations on the device, w/o copying back to host, for as long as possible. In some embodiments, the host 110 and DP compute engine 120 may share a common memory system. In those embodiments, authority or control over the data is transferred from the host to the computer engine. Or the compute engine obtains shared control of the data in memory. Herein, the compute engine is a term for a device DP-optimal hardware or non-device DP-optimal hardware. For such embodiments, the discussion of the transferred data herein implies that the DP compute engine has control over the data rather than the data has been moved from one memory to another.

At operation 306, the DP-capable hardware of the computing device defines the transferred data of the data set as a field. The field defines the logical arrangement of the data set as it is stored in the DP capable memory (e.g., node memory 138). The arguments of the DP call-site function call define the parameters of the field. Those parameters may include the rank (i.e., number of dimensions) of the data set and the data type of each element of the data set. The index and compute domain are other parameters that influence the definition of the field. These parameters may help define the shape of the processing of the field. When there is an exact type match then it is just an ordinary argument passing, but there may be projection or partial projection.

At operation 308, the DP capable hardware of the computing device prepares a DP kernel to be executed by multiple data parallel threads. The DP kernel is a basic iterative DP activity performed on a portion of the data set. Each instance of the DP kernel is an identical DP task. The particular DP task may be specified by the programmer when programming the DP kernel. The multiple processing elements (e.g., elements 140-146) represent each DP kernel instance.

At operation 310, each instance of the DP kernel running as part of the DP capable hardware of the computing device receives, as input, a portion of the data from the field. As is the nature of data parallelism, each instance of a DP kernel operates on different portions of the data set (as defined by the field). Therefore, each instance receives its own portion of the data set as input.

At operation 312, the DP capable hardware of the computing device invokes, in parallel, the multiple instances of the DP kernel in the DP capable hardware. With everything properly setup by the previous operations, the actual data parallel computations are performed at operation 312.

At operation 314, the DP capable hardware of the computing device gets output resulting from the invoked multiple instances of the DP kernel, the resulting output being stored in the DP capable memory. At least initially, the outputs from the execution of the DP kernel instances are gathered and stored in local DP capable memory (e.g., the node memory 128).

At operation 316, the computing device transfers the resulting output from the DP capable memory to the non-DP capable memory. Of course, if the memory is shared by the host and compute engine, then only control or authority need be transferred rather than the data itself. Once all of the outputs from the DP kernel instances are gathered and stored, the collective outputs are moved back to the non-DP host 110 from the DP compute engine 120.

Operation 318 represents the non-DP optimal hardware of the computing device performing one or more non-DP computations and doing so concurrently with parallel invocation of the multiple instances of the DP kernel (operation 312). These non-DP computations may be performed concurrently with other DP computations as well, such as those of operations 306, 308, 310, and 314. Moreover, these non-DP computations may be performed concurrently with other transfers of data between non-DP and DP memories, such as those of operations 304 and 316.

Multiple non-DP-optimal compute nodes (some hosts, some not) may be interacting with multiple DP-optimal compute nodes. Every single node is concurrently independent of each other. In fact, from an OS point of view, the node may be viewed as a separate OS or a separate OS process or at minimum separate OS threads.

Therefore, any compute node may perform computations concurrently with any other compute node. And synchronization is useful at many levels to optimally coordinate all the node computations.

The return transfer of outputs, shown as part of operation 316, is asynchronous to the calling program. That is, the program (e.g., program 118) that initiates the DP call-site function need not wait for the results of the DP call-site. Rather, the program may continue to perform other non-DP activity. The actual return transfer of output is the synchronization point.

At operation 320, the computing device continues as normal, performing one or more non-DP computations.

### Implementation Details

Implementation of the inventive concepts described herein to the C++ programming language, in particular, may involve the use of a template syntax to express most concepts and to avoid extensions to the core language. That template syntax may include variadic templates, which are templates that take a variable number of arguments. A template is a feature of the C++ program language that allows functions and classes to operate with generic types. That is, a function or class may work on many different data types without having to be rewritten for each one. Generic types enable raising data into the type system. Which allows custom domain specific semantics to be checked at compile-time by a standards compliant C++ compiler. The C++ lambdas are useful to the high productivity and usability of the DP programming model, as they allow expression and statements to be inserted in line with DP call-site functions. An appropriate compiler (e.g., compiler 116) may have accurate error messages and enforce some type of restrictions.

The arguments of a DP call-site function call are used to define the parameters of the field upon which the DP call-site function will operate. In other words, the arguments help define the logical arrangement of the field-defined data set.

In addition to the rules about interpreting arguments for fields, there are other rules that may be applied to DP call-site functions in one or more implementations: Passing identical scalar values to invocation, and avoiding defining an evaluation order.

If an actual parameter is a scalar value, the corresponding formal may be restricted either to have non-reference type or, in other embodiments, to have a “const” modifier. With this restriction, the scalar is passed identically to all kernel invocations. This is a mechanism to parameterize a compute node based on scalars copied from the host environment at the point of invocation.

Within a DP kernel invocation, a field may be restricted to being associated with at most one non-const reference or aggregate formal. In that situation, if a field is associated with a non-const reference or aggregate formal, the field may not be referenced in any way other than the non-const reference or aggregate formal. This restriction avoids having to define an evaluation order. It also prevents dangerous aliasing and can be enforced as a side-effect of hazard detection. Further, this restriction enforces read-before-write semantics by treating the target of an assignment uniformly as an actual, non-const, non-elemental parameter to an elemental assignment function.

For at least one implementation, the kernel may be defined as an extension to the C++ programming language using the “_declspec” keyword, where an instance of a given type is to be stored with a domain-specific storage-class attribute. More specifically, “_declspec(vector)” is used to define the kernel extension to the C++ language.

### Concluding Notes

As used in this application, the terms “component,” “module,” “system,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of example, both an application running on a controller and the controller can be a component. One or more components may reside within a process and/or thread of execution, and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter.

An implementation of the claimed subject may be stored on or transmitted across some form of computer-readable media. Computer-readable media may be any available media that may be accessed by a computer. By way of example, computer-readable media may comprise, but is not limited to, “computer-readable storage media” and “communications media.”

“Computer-readable storage media” include volatile and non-volatile, removable and non-removable media implemented in any method or technology for storage of information such as computer-readable instructions, computer-executable instructions, data structures, program modules, or other data. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies computer-readable instructions, computer-executable instructions, data structures, program modules, or other data in a modulated data signal, such as carrier wave or other transport mechanism. Communication media also includes any information delivery media.

As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an,” as used in this application and the appended claims, should generally be construed to mean “one or more”, unless specified otherwise or clear from context to be directed to a singular form.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

We claim:

1. A method that facilitates production of data parallel (DP) executable programs, the method comprising:
obtaining a representation of how to call a DP call-site function, wherein the representation includes indicators of arguments associated with the call for the DP call-site function;
based at least in part upon the DP call-site function representation, generating a set of executable instructions based upon the DP call-site function with its associated arguments, wherein the executable instructions perform, when executed on one or more computing devices, operations comprising:
defining a data set based upon the arguments, the data set being stored in a memory that is part of a DP capable hardware of the one or more computing devices;
performing the data parallel call-site function call upon the data set stored in the DP capable memory.

2. A method as recited in claim 1, wherein the function call, which is represented by the textual representation, comprises a DP primitive forall.

3. A method as recited in claim 1, wherein the function call, which is represented by the textual representation, is selected from a group of DP primitives consisting of: forall, reduce, scan, and sort.

4. A method as recited in claim 1, wherein the arguments, which are indicated by the indicators of the arguments associated with the call for the DP call-site function, include parameters defining the data set.

5. A method as recited in claim 1, wherein the arguments, which are indicated by the indicators of the arguments associated with the call for the DP call-site function, include parameters defining a logical arrangement of the data set, wherein those parameters include a rank of the data set, the rank being a number of dimensions of the data set.

6. A method as recited in claim 1, wherein the arguments, which are indicated by the indicators of the arguments associated with the call for the DP call-site function, include parameters defining a logical arrangement of the data set, wherein those parameters include a data type of the data in the data set.

7. A method as recited in claim 1, wherein the arguments, which are indicated by the indicators of the arguments associated with the call for the DP call-site function, include parameters defining a logical arrangement of the data set, wherein those parameters include a rank of the data set and a data type of the data in the data set, the rank being a number of dimensions of the data set.

8. A method as recited in claim 1, wherein the arguments, which are indicated by the indicators of the arguments associated with the call for the DP call-site function, include parameters indicating that at least a portion of the data set is to be stored in read-only memory.

9. A method as recited in claim 1, wherein the arguments, which are indicated by the indicators of the arguments associated with the call for the DP call-site function, include parameters defining a multi-dimensional logical arrangement of the data set, wherein the parameters include a compute domain of the data set, the compute domain defining an extent of each of the dimensions of the multi-dimensional logical arrangement of the data set.

10. A method as recited in claim 1, wherein the arguments, which are indicated by the indicators of the arguments associated with the call for the DP call-site function, include parameters defining at least a portion of the data set to be stored in a read-only area of the DP-capable memory.

11. A method as recited in claim 1, wherein the arguments, which are indicated by the indicators of the arguments associated with the call for the DP call-site function, are elemental.

12. A method as recited in claim 1, wherein the arguments, which are indicated by the indicators of the arguments associated with the call for the DP call-site function, are non-elemental.

13. A method as recited in claim 1, wherein the operations further comprise:
based upon the function call, generating multiple instances of a DP kernel;
invoking, in parallel, the multiple instances of the DP kernel in the DP capable hardware, wherein each invoked instance of a kernel performs a common set of instructions but on different portions of the data set.

14. A method as recited in claim 1, wherein the operations further comprise transferring the data set from non-DP capable memory to the DP capable memory.

15. A method as recited in claim 1, further comprising transferring the resulting output from the DP capable memory to the non-DP capable memory.

16. One or more computer-readable media storing processor-executable instructions that, when executed, cause one or more processors to perform operations, the operations comprising:
selecting a data set to be used for data parallel (DP) computation, the data set being stored in a memory that is not part of DP capable hardware of one or more computing devices;
transferring the selected data set from the non-DP capable memory to another memory that is part of DP capable hardware of the one or more computing devices;
defining data of the data set stored in the DP capable memory as a field;
generating multiple instances of a DP kernel;
receiving as input, by each instance of the DP kernel, a portion of the data from the field;
invoking, in parallel, the multiple instances of the DP kernel in the DP capable hardware;
obtaining output resulting from the invoked multiple instances of the DP kernel, the resulting output being stored in the DP capable memory;
concurrent with parallel invocation of the multiple instances of the DP kernel, performing one or more non-DP computations by hardware that is not part of DP capable hardware of the one or more computing devices; and
transferring the resulting output from the DP capable memory to the non-DP capable memory.

17. A method that facilitates execution of a data parallel (DP) executable program, the method comprising:
selecting a data set to be used for DP computation, the data set being stored in a memory that is not part of DP capable hardware of one or more computing devices;
transferring the selected data set from the non-DP capable memory to another memory that is part of DP capable hardware of the one or more computing devices;
invoking, in parallel, multiple instances of a DP kernel in the DP capable hardware; and
obtaining output resulting from the invoked multiple instances of the DP kernel, the resulting output being stored in the DP capable memory.

18. A method as recited in claim 17, further comprising:
defining the data set stored in the DP capable memory as a field;
generating the multiple instances of a DP kernel; and
receiving as input, by each instance of the DP kernel, a portion of the data from the field.

19. A method as recited in claim 17, further comprising transferring the resulting output from the DP capable memory to the non-DP capable memory.

20. A method as recited in claim 17, further comprising:
concurrent with parallel invocation of the multiple instances of the DP kernel, performing one or more non-DP computations by hardware that is not part of DP capable hardware of the one or more computing devices;
transferring the resulting output from the DP capable memory to the non-DP capable memory.
